(19) United States
(12) Patent Application Publication
(10) Pub. No.: US 2026/0015970 A1
(43) Pub. Date: Jan. 15, 2026

(54) POWER PLANT WITH EXHAUST GAS RECIRCULATION COMPRESSOR

(71) Applicant: GENERAL ELECTRIC TECHNOLOGY GMBH, Baden (CH)

(72) Inventors: Majed SAMMAK, Schenectady, NY (US); Raub Warfield SMITH, Schenectady, NY (US); Parag Prakash KULKARNI, Schenectady, NY (US)

(21) Appl. No.: 18/998,576

(22) PCT Filed: Jul. 29, 2022
(86) PCT No.: PCT/US2022/038776

§ 371 Date: Jan. 27, 2025

(51) Int. Cl. F02C 6/18; F02C 3/34; F02C 7/143

(52) U.S. Cl. CPC F02C 3/34; B01D 53/1475; F01K 23/10; F02C 7/143; F01K 7/38; F05D 2220/72; F05D 2260/61; F05D 2260/611; Y02E 20/16; Y02E 20/32

(57) ABSTRACT

A power plant includes a gas turbine engine, which includes a compressor and a turbine. The compressor includes a compressor outlet. The turbine discharges a first exhaust gas stream therefrom. A heat recovery steam generator extracts heat from the first exhaust gas stream and discharges a second exhaust gas stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards the compressor. A recirculation compressor selectively pressurizes the first portion of the cooled exhaust gas stream for discharge to the compressor outlet.

### BACKGROUND

The present disclosure relates generally to power generation systems and, more specifically, to systems that use recirculated exhaust gas and an exhaust gas recirculation compressor to enhance plant output.

At least some known power plants generate energy derived from combusting carbon and hydrogen-containing fuels such as, coal, oil, peat, waste, biofuel, natural gas, and the like. In addition to carbon and hydrogen, such fuels may contain oxygen, moisture, and/or contaminants. As such, the combustion of such fuels may result in the production of a gas stream containing contaminants in the form of ash, carbon dioxide (CO2), sulfur compounds (often in the form of sulfur oxides, referred to as “SOx”), nitrogen compounds (often in the form of nitrogen oxides, referred to as “NOx”), chlorine, mercury, and/or trace elements.

To facilitate removing the contaminants from the gas stream, at least some known power plants may use capture systems that attempt to capture contaminants prior to an exhaust stream being released into the atmosphere. For example, some known power plants use carbon capture systems that attempt to capture carbon dioxide (CO2) post combustion and store it underground to reduce an amount of CO2 released into the atmosphere. However, because of the power required for the carbon capture process, the process of carbon capture may decrease the overall efficiency of the power plant, and/or limit the power production of the power plant. Thus, at least some of such power plant systems operate at a decreased power production efficiency.

### BRIEF DESCRIPTION

In one aspect, a power plant including a gas turbine engine, which includes a compressor and a turbine, is provided. The compressor includes a compressor outlet. The turbine discharges a first exhaust gas stream therefrom. A heat recovery steam generator extracts heat from the first exhaust gas stream and discharges a second exhaust gas stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards the compressor. A recirculation compressor selectively pressurizes the first portion of the cooled exhaust gas stream for discharge to the compressor outlet.

In another aspect, a power plant including a gas turbine engine, which includes a compressor and a turbine, is provided. The compressor includes a compressor outlet. The turbine discharges a first exhaust gas stream therefrom. A heat recovery steam generator extracts heat from the first exhaust gas stream and discharges a second exhaust gas stream and a steam stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards the compressor. A recirculation compressor selectively pressurizes the first portion of the cooled exhaust gas stream for discharge to the compressor outlet. A steam turbine receives a first stream portion of the steam stream therein, and discharges a first extraction flow. A carbon capture system receives the first extraction flow and a second portion of the cooled exhaust gas stream.

In yet another aspect, a power plant including a gas turbine engine, which includes a compressor and a turbine, is provided. The compressor includes a compressor outlet. The turbine discharges a first exhaust gas stream therefrom. A heat recovery steam generator extracts heat from the first exhaust gas stream and discharges a second exhaust gas stream and a steam stream therefrom. A cooler cools the second exhaust gas stream, thereby defining a cooled exhaust gas stream, and discharges the cooled exhaust gas stream. An exhaust gas recirculation line channels a first portion of the cooled exhaust gas stream towards the compressor. A recirculation compressor selectively pressurizes the first portion of the cooled exhaust gas stream for discharge to the compressor outlet. A steam turbine receives a first stream portion of the steam stream therein, and discharges a first extraction flow. A non-condensing steam turbine receives a second stream portion of the steam stream therein, provides power to the recirculation compressor, and discharges a second extraction flow. A carbon capture system receives the first extraction flow, a second portion of the cooled exhaust gas stream, and the second extraction flow.

### BRIEF DESCRIPTION OF THE DRAWINGS

FIG. 1 is a schematic illustration of an exemplary power plant including an exhaust gas recirculation compressor.

FIG. 2 is a schematic illustration of an exemplary power plant including an exhaust gas recirculation compressor and a non-condensing steam turbine to power the exhaust gas recirculation compressor.

FIG. 3 is a schematic illustration of an alternative power plant including an exhaust gas recirculation compressor and a motor to power the exhaust gas recirculation compressor.

### DETAILED DESCRIPTION

The embodiments described herein relate to power generation systems that use recirculated exhaust gas and an exhaust gas recirculation compressor to enhance plant output.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

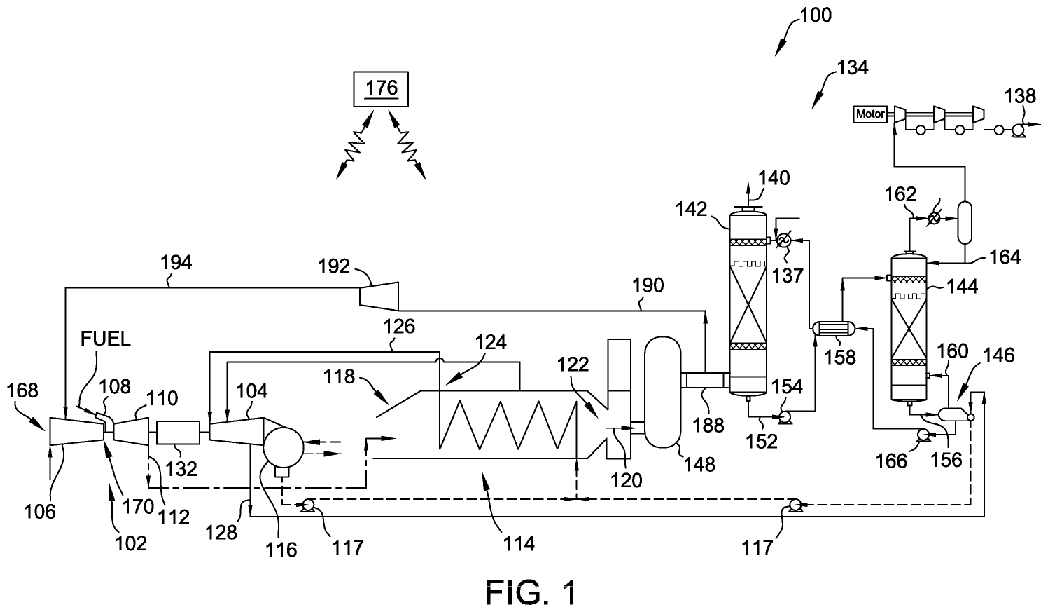

FIG. 1 is a schematic illustration of an exemplary power plant 100. In the exemplary embodiment, power plant 100 includes a gas turbine assembly 102 and a steam turbine 104. Gas turbine assembly 102 includes a compressor 106, a combustor 108, and a turbine 110 coupled together in a serial flow relationship. In operation, combustor 108 receives air from compressor 106 and fuel from a fuel supply and mixes the fuel and air to create a fuel-air mixture that is combusted to generate combustion gases. Combustion gases are channeled through turbine 110 and discharged from turbine 110 as a first exhaust gas stream 112. In the exemplary embodiment, power plant 100 also includes a steam cycle arrangement including a heat recovery steam generator (HRSG) 114 and steam turbine 104. In some embodiments, the steam cycle arrangement may also include other components, including a condenser 116 and at least one condensate pump 117.

In the exemplary embodiment, HRSG 114 includes an inlet 118 that receives first exhaust gas stream 112 from gas turbine assembly 102. Heat is extracted from first exhaust gas stream 112, and a second exhaust gas stream 120 is discharged from a first outlet 122. Second exhaust gas stream 120 is at a lower temperature than a temperature of first exhaust gas stream 112 entering inlet 118. HRSG 114 also includes a second outlet 124 that discharges a steam stream 126. Steam turbine 104 receives steam stream 126 and subsequently discharges a first extraction flow 128 therefrom. Any steam not extracted with first extraction flow 128 continues expansion to condensation within condenser 116. In some embodiments, steam turbine 104 may include additional steam admissions from HRSG 114. In the exemplary embodiment, gas turbine assembly 102 and steam turbine 104 are both coupled to a generator 132 that produces power using working fluids flowing through each. Alternatively, turbine assembly 102 and steam turbine 104 may be on separate shafts, with each coupled to a separate generator.

In the exemplary embodiment, power plant 100 also includes a carbon capture system 134. During operation, carbon capture system 134 produces a carbon dioxide stream 138. Carbon capture system 134 may include one or more separators, either used alone, or in combination with other separation processes, such as carbon dioxide selective membrane technologies, absorption processes, diaphragms, and the like. An exhaust stream or carbon depleted exhaust stream 140 may be discharged from carbon capture system 134 to the ambient environment. Exhaust stream 140 may also be further processed prior to discharge to the environment or elsewhere. At least a portion of carbon dioxide stream 138 may be increased to supercritical pressure for transport and/or storage, for example.

Carbon capture system 134 generally includes an absorber 142, a stripper 144, and a reboiler 146. In operation, second exhaust gas stream 120 discharged from HRSG 114 is channeled towards absorber 142. The exhaust gas may be pretreated for removal of particulates and impurities such as SOx and NOx before entry into absorber 142. In addition, in the exemplary embodiment, a first cooler 148 is coupled between HRSG 114 and carbon capture system 134. Alternatively, carbon capture system 134 may include at least one booster blower (not shown) to pressurize flow channeled towards carbon capture system 134. First cooler 148 may be, but is not limited to only being, a quench tower. First cooler 148 cools a portion of second exhaust gas stream 120 to be channeled towards carbon capture system 134.

A solvent 152, rich in carbon dioxide, is discharged from absorber 142 and is then channeled, via a pump 154, to stripper 144. Solvent 156, lean in carbon dioxide, is discharged from stripper 144 and is channeled back to an upper portion of absorber 142 via reboiler 146, a pump 166, and heat exchanger 158. Absorber 142 may be of any construction typical for providing gas-liquid contact and absorption. Absorber 142 and stripper 144 may incorporate a variety of internal components, such as trays, packings, and/or supports, for example. In one embodiment, absorber 142 absorbs carbon dioxide via a countercurrent flow from the exhaust gas entering absorber 142. Stripper 144 removes carbon dioxide from solvent 152. Absorber 142 and stripper 144 may be variably sized based on an amount of carbon dioxide to be removed, and may be variably sized according to various engineering design equations. Furthermore, a single stripper 144 may serve and be coupled to multiple absorbers 142.

In the exemplary embodiment, solvent 152 is preheated in a countercurrent heat exchanger 158 against solvent 156, and is subsequently channeled to stripper 144. Stripper 144 is a pressurized unit in which carbon dioxide is recovered from solvent 152. Stripper 144 generally incorporates reboiler 146 which receives a portion of solvent 156 exiting stripper 144. Reboiler 146 vaporizes solvent 156 and channels solvent vapor 160 back to stripper 144 to facilitate increased carbon dioxide separation. A single stripper 144 may be coupled to more than one reboiler 146. Reboiler 146 receives steam, such as from steam turbine 104 via first extraction flow 128 to provide heating duty in reboiler 146.

Vapor 162 exiting stripper 144 is partially condensed in condenser 136. The condensed portion of vapor 162 is returned to stripper 144 as reflux 164. Reflux 164 may be transferred through an accumulator (not shown) and a pump (not shown) before entry into stripper 144. Carbon dioxide stream 138 is removed from condenser 136 for transport and/or storage after compression.

In the exemplary embodiment, power plant 100 utilizes exhaust gas recirculation with post combustion carbon capture system 134. An exhaust gas recirculation stream 190 is drawn downstream from first cooler 148 and is channeled towards compressor 106. Compressor 106 includes a compressor inlet 168 and a compressor outlet 170. First cooler 148 may be, but is not limited to only being, a quench tower. A recirculation compressor 192 is coupled between cooler 148 and compressor 106. Recirculation compressor 192 receives exhaust gas recirculation stream 190 and discharges a compressed exhaust flow 194 towards compressor 106. Compressor 106 receives compressed exhaust flow 194 at compressor outlet 170. More specifically, compressed exhaust flow 194 is channeled towards compressor outlet 170 to facilitate improving the performance of power plant 100 by increasing the power generated by, and improving the efficiency of, gas turbine assembly 102. Additionally, compressed exhaust flow 194 is channeled towards compressor outlet 170 to facilitate improving the performance of carbon capture system 134 by increasing the carbon dioxide concentration of first exhaust gas stream 112 discharged from turbine 110, thereby improving the performance of power plant 100.

Exemplary power plant 100 may include a controller 176 used to dynamically adjust operation of power plant 100. For example, controller 176 may monitor and/or control the operation of recirculation compressor 192. Accordingly, in one embodiment, flow of exhaust gas recirculation stream 190 is adjusted by controller 176 to facilitate improving the output of power plant 100. That is, controller 176 may selectively modulate the flow of exhaust gas recirculation stream 190 drawn downstream from first cooler 148 as described herein, to facilitate improving the output of power plant 100. Controller 176 facilitates extending the useful life of components within power plant 100. Thus, the flow modulation provides an option for operators of power plant 100 to use when determining how to optimize performance and life consumption of gas turbine 102.

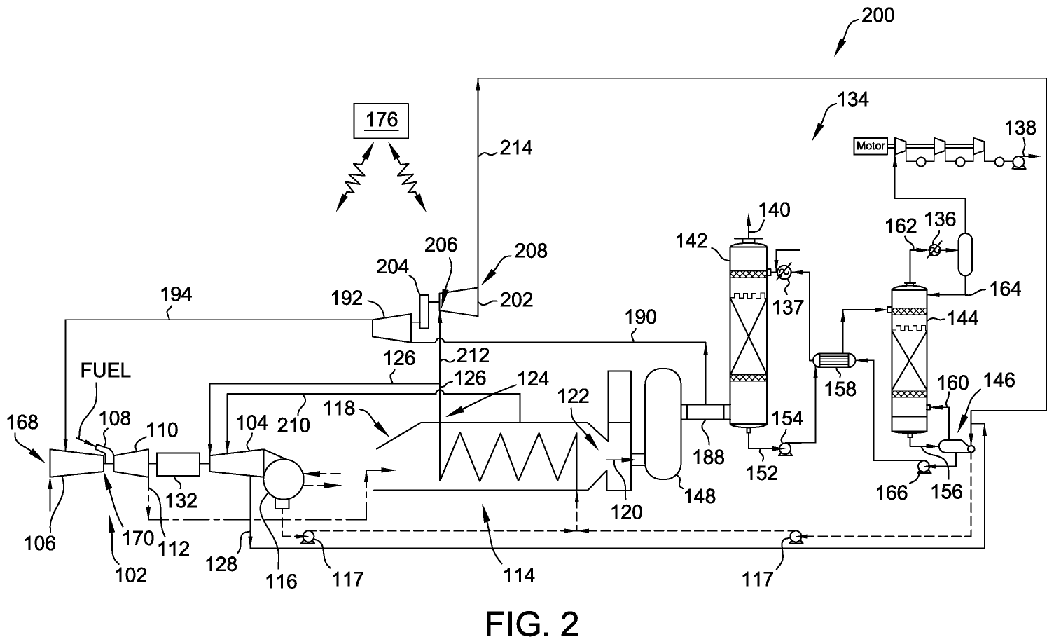

FIG. 2 is a schematic illustration of an exemplary power plant 200. The embodiment illustrated in FIG. 2 is similar to the embodiment illustrated in FIG. 1, with the differences noted herein, below, and as such, the same reference numbers are used in FIG. 2 as were used in FIG. 1. In FIG. 2, power plant 200 utilizes exhaust gas recirculation with post combustion carbon capture system 134. An exhaust gas recirculation stream 190 is drawn downstream from first cooler 148 and is channeled towards compressor 106. Compressor 106 includes a compressor inlet 168 and a compressor outlet 170. First cooler 148 may be, but is not limited to only being, a quench tower. A recirculation compressor 192 is coupled between cooler 148 and compressor 106. Recirculation compressor 192 receives exhaust gas recirculation stream 190 and discharges a compressed exhaust flow 194 towards compressor 106. Compressor 106 receives compressed exhaust flow 194 at compressor outlet 170. Exemplary power plant 200 utilizes a non-condensing steam turbine 202 to power recirculation compressor 192, thereby reducing the negative impact on the output and/or efficiency of power plant 100 from the powering of recirculation compressor 192. Non-condensing steam turbine 202 may be coupled to recirculation compressor 192 by a gearbox 204, as shown in FIG. 2. In some embodiments, non-condensing steam turbine 202 may be directly connected to recirculation compressor 192 by a shaft.

In the exemplary embodiment, non-condensing steam turbine 202 includes a non-condensing steam turbine inlet 206 and a non-condensing steam turbine exhaust outlet 208. HRSG 114 discharges steam stream 126 from second outlet 124. Steam stream 126 includes a first stream portion 210 channeled towards steam turbine 104 and a second stream portion 212 channeled towards non-condensing steam turbine 202. Non-condensing steam turbine 202 receives second stream portion 212 through non-condensing steam turbine inlet 206 and subsequently discharges a second extraction flow 214 through non-condensing steam turbine exhaust outlet 208. Reboiler 146 of carbon capture system 134 receives steam, such as from steam turbine 104 via first extraction flow 128 and from non-condensing steam turbine 202 via second extraction flow 214, to provide heating duty in reboiler 146.

Exemplary power plant 200 may include controller 176 used to dynamically adjust operation of power plant 200. For example, controller 176 may monitor and/or control the operation of recirculation compressor 192 and non-condensing steam turbine 202, and may also determine steam cycle losses resulting from discharging second extraction flow 214 and first extraction flow 128 towards carbon capture system 134, for example. In some embodiments, an optimum balance may be achieved between the loading of recirculation compressor 192 with non-condensing steam turbine 202 discharging second extraction flow 214 and steam turbine 104 discharging first extraction flow 128 to provide steam to reboiler 146.

Controller 176 may also dynamically determine the power consumption and steam cycle losses, and adjust operation of power plant 200 accordingly. In one embodiment, operation of recirculation compressor 192 and non-condensing steam turbine 202 is variably adjusted by controller 176 to facilitate improving plant output. That is, controller 176 may modulate the flow of exhaust gas recirculation stream 190, and thereby second extraction flow 214 channeled towards carbon capture system 134, to provide an improvement to the output of power plant 200. Controller 176 facilitates extending the useful life of components within power plant 200. Thus, the flow modulation provides an option for operators of power plant 200 to use when determining how to optimize performance and life consumption of plant equipment.

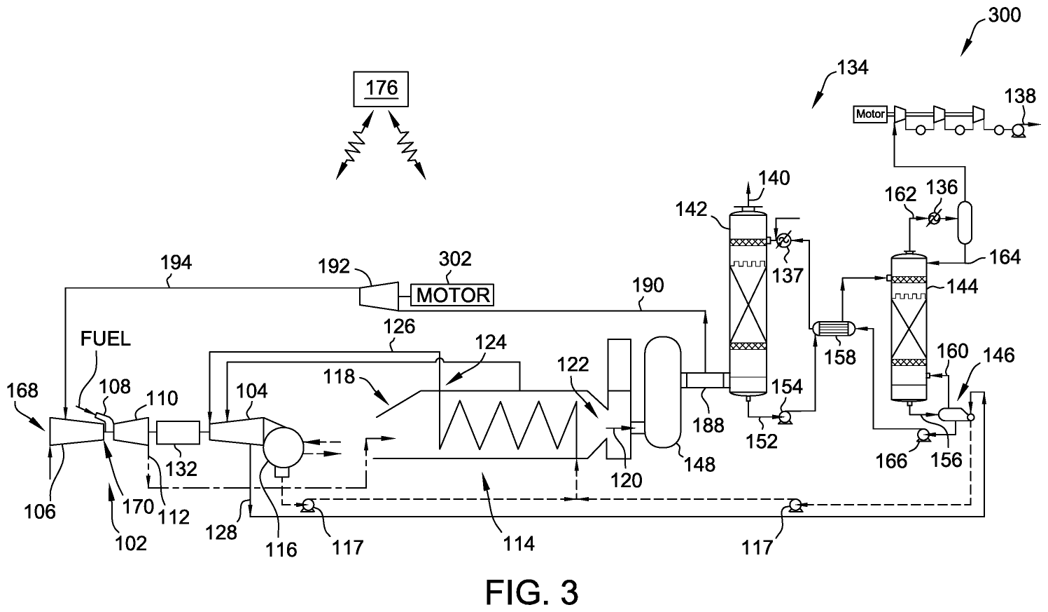

FIG. 3 is a schematic illustration of an alternative power plant 300. The embodiment illustrated in FIG. 3 is similar to the embodiment illustrated in FIGS. 1 and 2, with the differences noted herein, below, and as such, the same reference numbers are used in FIG. 3 as were used in FIGS. 1 and 2. In FIG. 3, power plant 300 utilizes exhaust gas recirculation with post combustion carbon capture system 134. An exhaust gas recirculation stream 190 is drawn downstream from first cooler 148 and is channeled towards compressor 106. Compressor 106 includes a compressor inlet 168 and a compressor outlet 170. First cooler 148 may be, but is not limited to only being, a quench tower. A recirculation compressor 192 is coupled between cooler 148 and compressor 106. Recirculation compressor 192 receives exhaust gas recirculation stream 190 and discharges a compressed exhaust flow 194 towards compressor 106. Compressor 106 receives compressed exhaust flow 194 at compressor outlet 170. Power plant 300 utilizes motor 302 to power recirculation compressor 192. Recirculation compressor 192 is coupled to motor 302 that provides the necessary driving power to recirculation compressor 192.

Power plant 300 may include controller 176 used to dynamically adjust operation of power plant 300. For example, controller 176 may monitor and/or control the operation of recirculation compressor 192. In one embodiment, operation of recirculation compressor 192 is variably adjusted by controller 176 to facilitate improving plant output. That is, controller 176 may modulate the flow of exhaust gas recirculation stream 190 to provide an improvement to the output of power plant 300.

The above description is meant to be exemplary only, and one skilled in the art will recognize that changes may be made to the embodiments described without departing from the scope of the invention disclosed. Modifications, which fall within the scope of the present invention, will be apparent to those skilled in the art, in light of a review of this disclosure, and such modifications are intended to fall within the appended claims.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

Further aspects of the invention are provided by the subject matter of the following clauses:

1. A power plant comprising: a gas turbine engine comprising a compressor having a compressor outlet, the gas turbine engine further comprising a turbine configured to discharge a first exhaust gas stream therefrom; a heat recovery steam generator configured to: extract heat from the first exhaust gas stream; and discharge a second exhaust gas stream therefrom; a cooler configured to cool the second exhaust gas stream, thereby defining a cooled exhaust gas stream, wherein the cooler discharges the cooled exhaust gas stream; an exhaust gas recirculation line configured to channel a first cooled stream portion of the cooled exhaust gas stream towards the compressor; and a recirculation compressor configured to selectively pressurize the first cooled stream portion of the cooled exhaust gas stream for discharge to the compressor outlet.

2. The power plant according to any preceding clause further comprising: the heat recovery steam generator configured to discharge a steam stream; a steam turbine configured to: receive a first stream portion of the steam stream therein; and discharge a first extraction flow; a carbon capture system configured to receive the first extraction flow; and a controller configured to modulate a flow of the first cooled stream portion of the cooled exhaust gas stream recirculated towards the compressor to facilitate increasing an output and/or an efficiency of the power plant.

3. The power plant according to any preceding clause further comprising: a non-condensing steam turbine configured to: receive a second stream portion of the steam stream therein; provide power to the recirculation compressor; and discharge a second extraction flow; and the carbon capture system configured to receive the second extraction flow.

4. The power plant according to any preceding clause further comprising the carbon capture system comprising a reboiler configured to receive the first extraction flow and the second extraction flow.

5. The power plant according to any preceding clause further comprising the carbon capture system configured to receive a second cooled stream portion of the cooled exhaust gas stream.

6. The power plant according to any preceding clause further comprising a motor configured to provide power to the recirculation compressor.

7. The power plant according to any preceding clause, wherein the controller is further configured to: determine performance of the power plant resulting from discharging the first extraction flow and the second extraction flow to the carbon capture system; and modulate the flow of the first cooled stream portion of the cooled exhaust gas stream recirculated towards the compressor to facilitate increasing the output and/or the efficiency of the power plant.

8. A power plant comprising: a gas turbine engine comprising a compressor having a compressor outlet, the gas turbine engine further comprising a turbine configured to discharge a first exhaust gas stream therefrom; a heat recovery steam generator configured to: extract heat from the first exhaust gas stream; and discharge a second exhaust gas stream and a steam stream therefrom; a cooler configured to cool the second exhaust gas stream, thereby defining a cooled exhaust gas stream, wherein the cooler discharges the cooled exhaust gas stream; an exhaust gas recirculation line configured to channel a first cooled stream portion of the cooled exhaust gas stream towards the compressor; a recirculation compressor configured to selectively pressurize the first cooled stream portion of the cooled exhaust gas stream for discharge to the compressor outlet; a steam turbine configured to: receive a first stream portion of the steam stream therein; and discharge a first extraction flow; and a carbon capture system configured to receive the first extraction flow and a second cooled stream portion of the cooled exhaust gas stream.

9. The power plant according to any preceding clause further comprising a controller configured to modulate a flow of the first cooled stream portion of the cooled exhaust gas stream recirculated towards the compressor to facilitate increasing an output and/or an efficiency of the power plant.

10. The power plant according to any preceding clause further comprising: a non-condensing steam turbine configured to: receive a second stream portion of the steam stream therein; provide power to the recirculation compressor; and discharge a second extraction flow; and the carbon capture system configured to receive the second extraction flow.

11. The power plant according to any preceding clause further comprising the carbon capture system comprising a reboiler configured to receive the first extraction flow and the second extraction flow.

12. The power plant according to any preceding clause further comprising a motor configured to provide power to the recirculation compressor.

13. The power plant according to any preceding clause, wherein the controller is further configured to: determine power consumption resulting from discharging the first extraction flow and the second extraction flow to the carbon capture system; and modulate the flow of the first cooled stream portion of the cooled exhaust gas stream recirculated towards the compressor to facilitate increasing the output and/or the efficiency of the power plant.

14. A power plant comprising: a gas turbine engine comprising a compressor having a compressor outlet, the gas turbine engine further comprising a turbine configured to discharge a first exhaust gas stream therefrom; a heat recovery steam generator configured to: extract heat from the first exhaust gas stream; and discharge a second exhaust gas stream and a steam stream therefrom; a cooler configured to cool the second exhaust gas stream, thereby defining a cooled exhaust gas stream, wherein the cooler discharges the cooled exhaust gas stream; an exhaust gas recirculation line configured to channel a first cooled stream portion of the cooled exhaust gas stream towards the compressor; a recirculation compressor configured to selectively pressurize the first cooled stream portion of the cooled exhaust gas stream for discharge to the compressor outlet; a steam turbine configured to: receive a first stream portion of the steam stream therein; and discharge a first extraction flow; a non-condensing steam turbine configured to: receive a second stream portion of the steam stream therein; provide power to the recirculation compressor; and discharge a second extraction flow; and a carbon capture system configured to receive the first extraction flow, the second extraction flow, and a second portion of the cooled exhaust gas stream.

15. The power plant according to any preceding clause further comprising the carbon capture system comprising a reboiler configured to receive the first extraction flow and the second extraction flow.

While the invention has been described in terms of various specific embodiments, those skilled in the art will recognize that the invention can be practiced with modification within the spirit and scope of the claims.

What is claimed is:

1. A power plant comprising:
a gas turbine engine comprising a compressor having a compressor outlet, the gas turbine engine further comprising a turbine configured to discharge a first exhaust gas stream therefrom;
a heat recovery steam generator configured to:
extract heat from the first exhaust gas stream; and
discharge a second exhaust gas stream therefrom;
a cooler configured to cool the second exhaust gas stream, thereby defining a cooled exhaust gas stream, wherein the cooler discharges the cooled exhaust gas stream;
an exhaust gas recirculation line configured to channel a first cooled stream portion of the cooled exhaust gas stream towards the compressor; and
a recirculation compressor configured to selectively pressurize the first cooled stream portion of the cooled exhaust gas stream for discharge to the compressor outlet.

2. The power plant in accordance with claim 1 further comprising:
the heat recovery steam generator configured to discharge a steam stream;
a steam turbine configured to:
receive a first stream portion of the steam stream therein; and
discharge a first extraction flow;
a carbon capture system configured to receive the first extraction flow; and
a controller configured to modulate a flow of the first cooled stream portion of the cooled exhaust gas stream recirculated towards the compressor to facilitate increasing an output and/or an efficiency of the power plant.

3. The power plant in accordance with claim 2 further comprising:
a non-condensing steam turbine configured to:
receive a second stream portion of the steam stream therein;
provide power to the recirculation compressor; and
discharge a second extraction flow; and
the carbon capture system configured to receive the second extraction flow.

4. The power plant in accordance with claim 3 further comprising the carbon capture system comprising a reboiler configured to receive the first extraction flow and the second extraction flow.

5. The power plant in accordance with claim 2 further comprising the carbon capture system configured to receive a second cooled stream portion of the cooled exhaust gas stream.

6. The power plant in accordance with claim 2 further comprising a motor configured to provide power to the recirculation compressor.

7. The power plant in accordance with claim 3, wherein the controller is further configured to:
determine performance of the power plant resulting from discharging the first extraction flow and the second extraction flow to the carbon capture system; and
modulate the flow of the first cooled stream portion of the cooled exhaust gas stream recirculated towards the compressor to facilitate increasing the output and/or the efficiency of the power plant.

8. A power plant comprising:
a gas turbine engine comprising a compressor having a compressor outlet, the gas turbine engine further comprising a turbine configured to discharge a first exhaust gas stream therefrom;
a heat recovery steam generator configured to:
extract heat from the first exhaust gas stream; and
discharge a second exhaust gas stream and a steam stream therefrom;
a cooler configured to cool the second exhaust gas stream, thereby defining a cooled exhaust gas stream, wherein the cooler discharges the cooled exhaust gas stream;
an exhaust gas recirculation line configured to channel a first cooled stream portion of the cooled exhaust gas stream towards the compressor;
a recirculation compressor configured to selectively pressurize the first cooled stream portion of the cooled exhaust gas stream for discharge to the compressor outlet;
a steam turbine configured to:
receive a first stream portion of the steam stream therein; and
discharge a first extraction flow; and
a carbon capture system configured to receive the first extraction flow and a second cooled stream portion of the cooled exhaust gas stream.

9. The power plant in accordance with claim 8 further comprising a controller configured to modulate a flow of the first cooled stream portion of the cooled exhaust gas stream recirculated towards the compressor to facilitate increasing an output and/or an efficiency of the power plant.

10. The power plant in accordance with claim 9 further comprising:
a non-condensing steam turbine configured to:
receive a second stream portion of the steam stream therein;
provide power to the recirculation compressor; and
discharge a second extraction flow; and
the carbon capture system configured to receive the second extraction flow.

11. The power plant in accordance with claim 10 further comprising the carbon capture system comprising a reboiler configured to receive the first extraction flow and the second extraction flow.

12. The power plant in accordance with claim 8 further comprising a motor configured to provide power to the recirculation compressor.

13. The power plant in accordance with claim 10, wherein the controller is further configured to:
determine power consumption resulting from discharging the first extraction flow and the second extraction flow to the carbon capture system; and
modulate the flow of the first cooled stream portion of the cooled exhaust gas stream recirculated towards the compressor to facilitate increasing the output and/or the efficiency of the power plant.

14. A power plant comprising:
a gas turbine engine comprising a compressor having a compressor outlet, the gas turbine engine further comprising a turbine configured to discharge a first exhaust gas stream therefrom;
a heat recovery steam generator configured to:
extract heat from the first exhaust gas stream; and
discharge a second exhaust gas stream and a steam stream therefrom;
a cooler configured to cool the second exhaust gas stream, thereby defining a cooled exhaust gas stream, wherein the cooler discharges the cooled exhaust gas stream;
an exhaust gas recirculation line configured to channel a first cooled stream portion of the cooled exhaust gas stream towards the compressor;
a recirculation compressor configured to selectively pressurize the first cooled stream portion of the cooled exhaust gas stream for discharge to the compressor outlet;
a steam turbine configured to:
receive a first stream portion of the steam stream therein; and
discharge a first extraction flow;
a non-condensing steam turbine configured to:
receive a second stream portion of the steam stream therein;
provide power to the recirculation compressor; and
discharge a second extraction flow; and
a carbon capture system configured to receive the first extraction flow, the second extraction flow, and a second portion of the cooled exhaust gas stream.

15. The power plant in accordance with claim 14 further comprising the carbon capture system comprising a reboiler configured to receive the first extraction flow and the second extraction flow.
